(19) United States
(12) Patent Application Publication
(10) Pub. No.: US 2017/0026879 A1
(43) Pub. Date: Jan. 26, 2017

(54) BASE STATION AND BASE-STATION CONTROL METHOD

(71) Applicant: NEC CORPORATION, Tokyo (JP)

(72) Inventor: Yohsuke FUKUDA, Tokyo (JP)

(73) Assignee: NEC Corporation, Tokyo (JP)

(21) Appl. No.: 15/125,802

(22) PCT Filed: Mar. 11, 2015
(86) PCT No.: PCT/JP2015/001317

§ 371 Date: Sep. 13, 2016

(30) Foreign Application Priority Data
Mar. 18, 2014 (JP) 2014-055285

(51) Int. Cl. H04W 36/00; H04W 16/32; H04W 36/04

(52) U.S. Cl. CPC H04W 36/0061; H04W 36/04; H04W 16/32

(57) ABSTRACT

In order to facilitate traffic offload to small base stations, the base station includes a neighboring cell list including information on other base stations around the base station and a neighboring base station information management means which manages the neighboring cell list, and which, based on a criterion that is different depending on whether a base station included in the neighboring cell list is a small base station having a subordinate small cell or a non-small base station, deletes information on the base station included in the neighboring cell list from the neighboring cell list at a predetermined frequency.

### TECHNICAL FIELD

The present invention relates to a base station and a method for controlling the base station, and more particularly, relates to a base station used in a mobile communication system and a method for controlling the base station.

### BACKGROUND ART

Spread of mobile communication terminals represented by smartphones in recent years has considerably increased traffic of mainly data in mobile communication systems. As a means for distributing (offloading) traffic of a base station to another base station, particularly, in an urban densely populated area, a heterogeneous network (hereinafter, referred to as “HetNet”) is known. In the HetNet, a cell covering a relatively wide service area and accommodating a large number of users (a macrocell) disposes therein a base station having a subordinate small cell. A small cell is a cell smaller in scale than the macrocell. Hereinafter, a radio base station having a subordinate macrocell is referred to as a “macro base station” and a radio base station having a subordinate small cell is referred to as a “small base station.”

For example, a cell covering a narrower service area than a peripheral cell may be called as a small cell. Further, a base station of which transmission power is less than transmission power of a peripheral macro base station may be called as a small base station. Alternatively, for example, a base station having a cell covering an area of 50 m in radius or less, a base station accommodating 10 users or less, or a base station of which transmission power is less than 10 W may be called as a small base station, and a cell subordinate to such a base station may be called as a small cell. Examples of the small cell may include a cell called as a microcell, a picocell, or a femtocell.

In a mobile communication system in which a macro base station and a small base station are coexistent, enhancing handover from the macro base station to the small base station enables to transfer traffic of the macro base station to the small base station. That is, offloading traffic from the macro base station to the small base station can prevent the traffic of the macro base station from becoming tight. Accordingly, improvement in quality of a mobile communication service is expected.

Meanwhile, a base station used in the mobile communication system holds information on other cells neighboring a cell in control of the base station (neighboring cells) and information on base stations respectively subordinating the neighboring cells (neighboring base stations), as a “neighboring cell list.” The base station dynamically adds or deletes the information on the neighboring cell to or from the neighboring cell list.

There is generally an upper limit for the number of neighboring base stations registerable in the neighboring cell list. For example, in a Long Term Evolution (LTE) system specified by the 3rd Generation Partnership Project (3GPP), the upper limit for the number of neighboring base stations registerable in the neighboring cell list is 32. Thus, when the number of neighboring base stations registered in the neighboring cell list reaches 32, a part of the already registered neighboring base stations needs to be deleted to additionally register a neighboring base station.

PTLs 1 to 3 describe a technique of deleting information on neighboring cells (or neighboring base stations) from a neighboring cell list. A base station described in PTL 1 deletes a cell determined as being poor in radio quality from the neighboring cell list. A base station described in PTL 2 deletes a neighboring base station to which no handover has been performed within a predetermined period of time, from the neighboring cell list. A base station controller described in PTL 3 deregisters a neighboring zone in an ascending order of the number of times of executed handover when the number of registered neighboring zones exceeds a registerable number.

### CITATION LIST

### Patent Literature

[PTL 1] Japanese Unexamined Patent Application Publication No. 2013-026742 (paragraph [0088])

[PTL 2] Japanese Unexamined Patent Application Publication No. 2011-004101 (paragraph [0061])

[PTL 3] Japanese Unexamined Patent Application Publication No. H09-284828 (paragraph [0021])

### SUMMARY OF INVENTION

### Technical Problem

In the HetNet, a macrocell and a small cell are coexistent. Thus, a neighboring cell list of base stations used in the HetNet includes a macro base station and a small base station. Consequently, in deleting information on a base station included in the neighboring cell list in the HetNet, there may arise a case where information on the small base station with a low handover frequency is to be a deletion target. However, deleting the information on the small base station from the neighboring cell list results in less or no small base stations available for traffic offload. In other words, deleting the information on the small base station from the neighboring cell list may reduce an amount of traffic offload to small base stations, failing to achieve expected improvement in communication quality. Further, none of PTLs 1 to 3 describes a technique for solving a problem that deleting the information on the small base station from the neighboring cell list suppresses traffic offload from the macro base station to the small base stations.

### OBJECTS OF THE INVENTION

An object of the present invention is to facilitate traffic offload to small base stations.

### Solution to Problem

A base station of the present invention is used for communication with a terminal existing in a cell subordinate to the base station, the base station comprising a neighboring cell list including information on other base stations around the base station and neighboring base station information management means for managing the neighboring cell list and deleting information on a base station included in the neighboring cell list at a predetermined frequency from the neighboring cell list based on a criterion different depending on whether the base station included in the neighboring cell list is a small base station having a subordinate small cell or a non-small base station.

A method of the present invention for controlling a base station, the method comprising deleting, at a predetermined frequency from a neighboring cell list, information on a base station included in the neighboring cell list including information on base stations used in a mobile communication system, based on a criterion different depending on whether the base station included in the neighboring cell list is a small base station having a subordinate small cell or a non-small base station.

### Advantageous Effects of Invention

A base station and a method for controlling the base station according to the present invention exhibit the effect of facilitating traffic offload to small base stations.

### BRIEF DESCRIPTION OF DRAWINGS

FIG. 1 is a block diagram illustrating a configuration of a wireless communication system according to a first exemplary embodiment.

FIG. 2 is a sequence diagram illustrating an example of a handover operation of the wireless communication system according to the first exemplary embodiment.

FIG. 3 is a flowchart illustrating a procedure of updating a neighboring cell list according to the first exemplary embodiment.

FIG. 4 is a flowchart illustrating a procedure of updating a neighboring cell list according to a second exemplary embodiment.

FIG. 5 is a flowchart illustrating a procedure of updating a neighboring cell list according to a third exemplary embodiment.

### DESCRIPTION OF EMBODIMENTS

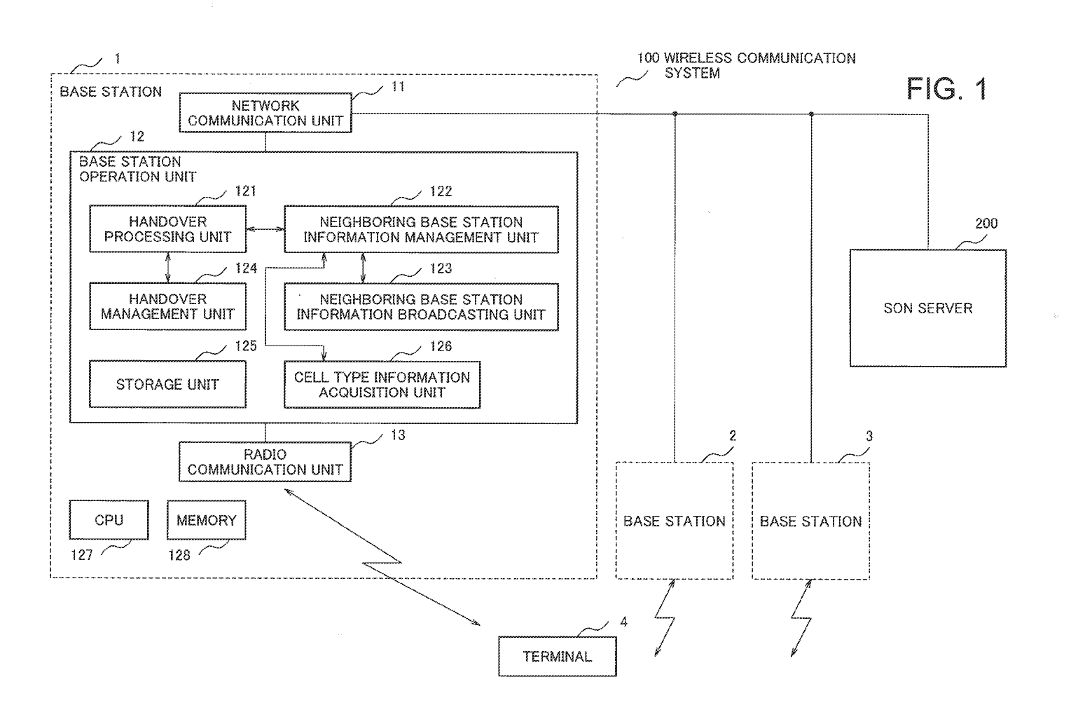

FIG. 1 is a block diagram illustrating a configuration of a wireless communication system 100 according to a first exemplary embodiment of the present invention. The wireless communication system 100 is an LTE network specified by the 3GPP and includes base stations 1 to 3 and a terminal 4. The base stations 1 to 3 are radio base stations used in LTE. The terminal 4 is a mobile communication terminal adapted for LTE, such as a smartphone. The base stations 1 to 3 include the same configuration and function and thus, the following describes the base station 1, omitting the description of the base stations 2 and 3.

Note that the wireless communication system 100 may further include a Self Organized Network (SON) server 200. The SON server 200 includes a function of automatically setting devices which constitute a mobile communication system, such as the base stations 1 to 3. The SON server 200 is disposed so as to be capable of communicating with the base stations 1 to 3.

The base station 1 includes a network communication unit 11, a base station operation unit 12, and a radio communication unit 13. The base station operation unit 12 includes a handover processing unit 121, a neighboring base station information management unit 122, a neighboring base station information broadcasting unit 123, a handover management unit 124, a storage unit 125, and a cell type information acquisition unit 126. The storage unit 125 is, for example, a semiconductor non-volatile memory. The storage unit 125 stores a time interval T for use in deleting information on a neighboring base station. The storage unit 125 further stores information necessary for the operation of the base station operation unit 12.

The base station 1 may further include a central processing unit (CPU) 127 and a memory 128. The memory 128 is, for example, a semiconductor non-volatile memory. The memory 128 stores a program executed by the CPU 127. The function of the base station 1 to be described below may be achieved by the CPU 127 executing the program for controlling each unit of the base station 1.

The radio communication unit 13 is a radio interface circuit which includes a function of communicating with the terminal 4 and is adapted for LTE. The radio communication unit 13 may further include a function of communicating with radio communication units of the other base stations 2 and 3. The base station 1 wirelessly communicates with the terminal 4 adapted for LTE via the radio communication unit 13.

The network communication unit 11 is an interface circuit for communicating with network communication units 11 which are also included in the base stations 2 and 3. The base stations 1 to 3 transmit and receive control messages via the network communication units 11. The communication means of the network communication unit 11 is not limited to wireless communication. The network communication unit 11 may communicate with the network communication units 11 of the other base stations 2 and 3 by wired communication. The network communication unit 11 may include an X2 interface for inter-base-station communication specified in LTE.

The control messages transmitted from the base station 1 are received by the base station 2 and the base station 3. The inter-base-station control messages transmitted from the base station 1 are generally transmitted via the network communication units 11, which are included in each of the base stations. The inter-base-station control messages, however, may be transmitted and received by the radio communication units 13, which are included in each of the base stations 1 to 3. Namely, the radio communication unit 13 of the base station 1 may transmit the control messages to the other base stations and the radio communication units 13 of the other base stations may receive the control messages transmitted from the base station 1.

Each of the inter-base-station control messages includes cell type information. The cell type information indicates whether a cell of each of the base stations transmitting the control messages is a small cell or a non-small cell. In other words, the cell type information indicates whether the base station in the cell is a small base station or a non-small base station (for example, a macro base station). The cell type information is set for each base station, and each of the base stations stores the set cell type information.

The handover processing unit 121 determines a handover destination base station on the occurrence of handover of the terminal 4. The neighboring base station information management unit 122 manages a neighboring cell list. The neighboring base station information broadcasting unit 123 generates broadcast information for informing a plurality of terminals of the neighboring cell list. The broadcast information is broadcasted from the radio communication unit 13 and received by the terminals subordinate to the base station 1.

The neighboring cell list of the base station 1 records information on neighboring cells and information on neighboring base stations of the base station 1. The handover management unit 124 manages a handover management table. The handover management table records handover occurrence times for all the neighboring base stations registered in the neighboring cell list.

The cell type information acquisition unit 126 extracts the cell type information from each of the control messages received from the other base stations. The extracted cell type information is stored in association with each of the base stations having transmitted the control messages. The cell type information is stored in the neighboring cell list in correspondence with the information on each of the base stations. Alternatively, the cell type information may be stored in the storage unit 125. When the cell type information is included in a control message notified from the terminal 4, the cell type information acquisition unit 126 extracts the cell type information from the control message received from the terminal 4.

Namely, the base station 1 can determine whether the base station in the neighboring cell is the small base station or the non-small base station by referring to the cell type information on the neighboring cell.

The above-described functions of the handover processing unit 121, the neighboring base station information management unit 122, the neighboring base station information broadcasting unit 123, the handover management unit 124, and the cell type information acquisition unit 126 are achieved by the program executed by the CPU 127 or an electronic circuit.

The cell type information may be included in the control messages transmitted from the radio communication unit 13 of the base station 1 and notified to the other base stations. In this case, the radio communication units 13 of the other base stations notify the respective cell type information acquisition units 126 of the control messages received from the radio communication unit 13 of the base station 1.

Next, the procedure of handover between base stations by the terminal 4 belonging to the base station 1 is described. In the following, description on the function known in common mobile communication systems, such as a procedure of determining a handover destination base station in the wireless communication system 100, will be omitted as appropriate.

The radio communication unit 13 of a handover origination base station and the radio communication unit 13 of a handover destination base station respectively transmit and receive the control message for handover to and from the terminal 4. The terminal 4 receives intensities of down signals (Reference Signals) from the base station 1 to which the terminal 4 currently belongs and from the base stations 2 and 3 neighboring the base station 1 and measures communication quality between the terminal 4 and each of the base stations based on the received intensities of the down signals. Any indexes other than the received intensities of the down signals (for example, a signal-to-noise ratio or an error rate of the received signal) may be used as the communication quality. The terminal 4 transmits the measured communication quality to the base station 1 by using the control message.

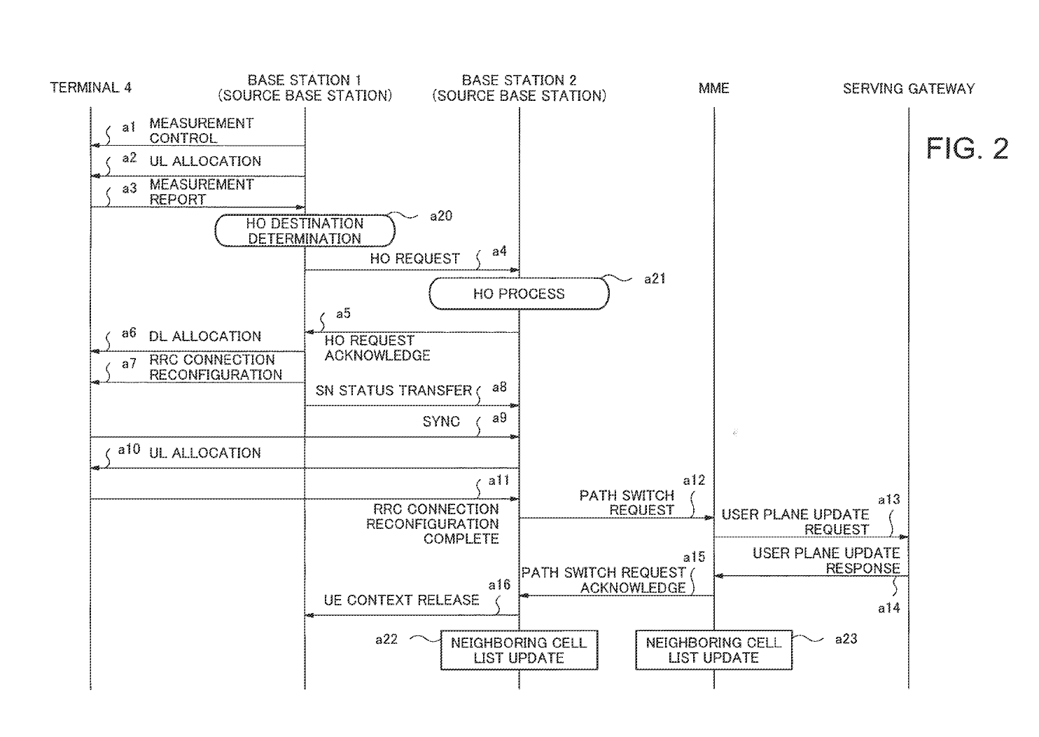

FIG. 2 is a sequence diagram illustrating an example of a handover operation of the wireless communication system 100. FIG. 2 describes the case where the handover origination base station (hereinafter, referred to as a “source base station”) corresponds to the base station 1 in FIG. 1 and the handover destination base station (hereinafter, referred to as a “target base station”) corresponds to the base station 2.

In a Measurement Control (Step a1 in FIG. 2), the base station 1 requests the terminal 4 to transmit information on neighboring base stations of the terminal 4. The base station 1 then allocates an uplink (UL) resource to the terminal 4 (a2).

The base station 1 receives a Measurement Report, being an Acknowledge for the Measurement Control, from the terminal 4 (a3). The Measurement Report includes information on the communication quality collected by the terminal 4 and indicating the communication quality between the terminal 4 and each of the neighboring base stations thereof, and information on radio resources of the terminal 4 and the base stations therearound. The Measurement Report may include the cell type information on the neighboring base stations for each of which the communication quality has been measured. The Measurement Report having been received by the radio communication unit 13 of the base station 1 is input to the base station operation unit 12. The base station operation unit 12 saves the contents of the Measurement Report. For example, the neighboring base station information management unit 122 writes the contents of the Measurement Report in the neighboring cell list in association with the base stations.

The handover processing unit 121 determines the target base station based on the communication quality information and the information on the radio resources included in the Measurement Report (“HO destination determination”, a20). FIG. 2 describes the case where the target base station corresponds to the base station 2 in FIG. 1.

The handover processing unit 121 notifies the neighboring base station information management unit 122 of information on the determined target base station. The handover processing unit 121 further notifies the handover management unit 124 of the information on the target base station and a handover occurrence time of the target base station.

The handover management unit 124 manages the handover management table. The handover management table holds the handover occurrence times for all the neighboring base stations registered in the neighboring cell list. The handover management unit 124 updates the handover management table based on the information on the target base station and the handover occurrence time of the target base station notified from the handover processing unit 121.

For the case when the handover management table has only the information on the target base station registered thereon, the handover management unit 124 adds the handover occurrence time to the handover management table upon acquiring the information on the target base station and the latest handover occurrence time of the target base station. For the case when the information on the target base station has the handover occurrence time registered therein, the handover management unit 124 adds the latest handover occurrence time of the target base station to the aforementioned handover occurrence time, or alternatively, updates the handover occurrence time of the target base station. For the case when the handover management table has no information on the target base station registered thereon, the handover management unit 124 registers the information on the target base station together with the handover occurrence time of the target base station on the handover management table. In this way, the handover management unit 124 updates data which is recorded on the handover management table and which relates to the latest handover occurrence time or the notified handover occurrence time of the target base station.

The handover processing unit 121 transmits a Handover Request via the network communication unit 11 to the base station 2 selected as being the target base station (a4).

Next, the operation of the target base station (base station 2) is described. The base station 2 having received the Handover Request (a4) extracts information on the source base station (base station 1) from the Handover Request by the handover processing unit 121 of the base station 2, and transitions to a handover process (“HO process”, a21). The base station 2 returns a Handover Request Acknowledge to the base station 1 (a5). In this way, the handover processing unit 121 of the base station 2 collects the handover occurrence time and the information on the source base station included in the control message.

The handover process (a21) in the target base station is described. The handover processing unit 121 of the base station 2 notifies the neighboring base station information management unit 122 of the received information on the base station 1. The handover processing unit 121 of the base station 2 further notifies the handover management unit 124 of the base station 2 of the collected information on the base station 1 and the handover occurrence time of the base station 1.

The handover management unit 124 of the base station 2 stores, on the handover management table, handover occurrence times for all the neighboring base stations registered in the neighboring cell list managed by the neighboring base station information management unit 122 of the base station 2. The handover management unit 124 updates the handover management table of the base station 2 based on the input information on the base station 1 and the handover occurrence time from the base station 1 to the base station 2.

The basic procedure for updating the handover management table of the base station 2 is the same as the procedure for updating the handover management table of the base station 1. Namely, the handover management unit 124 of the base station 2 acquires the latest handover occurrence time from the source base station (base station 1). For the case when the information on the source base station has been already registered, the base station 2 adds the handover occurrence time to the handover management table in correspondence with the source base station. For the case when the information on the source base station has the handover occurrence time registered therein, the handover management unit 124 adds the handover occurrence time of the source base station, or alternatively, updates the handover occurrence time to the latest time. For the case when the handover management table has no information on the source base station registered thereon, the handover management unit 124 registers the handover occurrence time to the handover management table in correspondence with the information on the source base station. The above processing is executed in the HO process (a21).

The base station 1 having received the Handover Request Acknowledge (a5) from the base station 2 transmits a Down Link (DL) Allocation Message and a Radio Resource Control (RRC) Connection Reconfiguration Message to the terminal 4 (a6, a7). The base station 1 further transmits a Sequence Number (SN) Status Transfer to the base station 2 (a8).

The terminal 4 having received the RRC Connection Reconfiguration Message (a7) transmits a Sync Request to the base station 2 (a9). Upon receiving a UL Allocation (a10) from the base station 2, the terminal 4 returns a RRC Connection Reconfiguration Complete Message to the base station 2 (a11).

The base station 2 having received the RRC Connection Reconfiguration Complete Message transmits a Path Switch Request to a Mobility Management Entity (MME) (a12). The MME transmits a User Plane Update Request addressed to a Serving Gateway (a13). In response to the User Plane Update Request, a User Plane Update Response (a14) and a Path Switch Request Acknowledge (a15) are respectively transmitted, and the terminal context is released (UE Context Release, a16). This switches a user plane path from the source base station side to the target base station side.

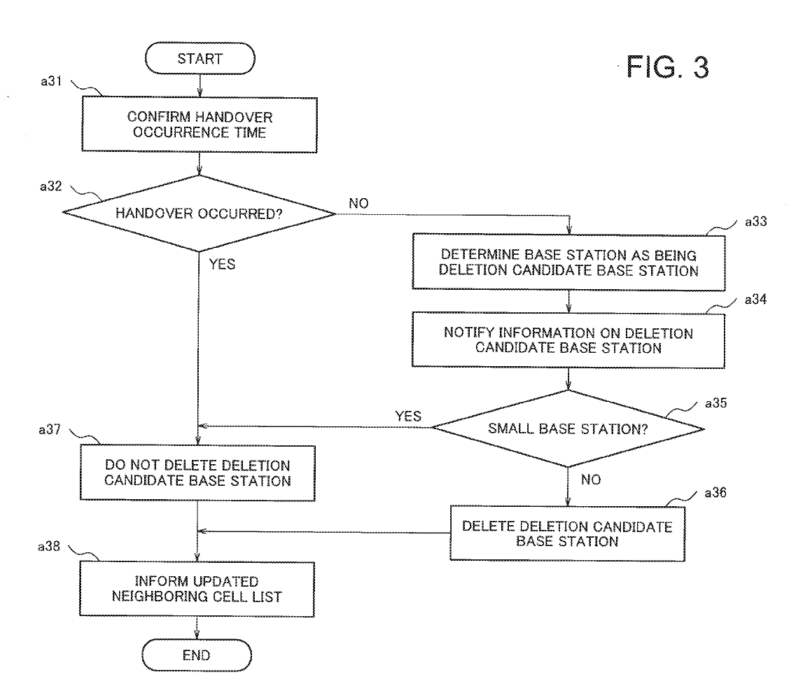

The handover management unit 124 of the base station 1 or the base station 2 periodically updates the neighboring cell list (a22, a23). The following describes a procedure of updating the neighboring cell list. FIG. 3 is a flowchart illustrating the procedure of updating the neighboring cell list according to the first exemplary embodiment. The procedure in FIG. 3 is common between the source base station and the target base station.

The handover management unit 124 of the base station 1 or the base station 2 refers to the handover management table at a predetermined frequency and confirms the handover occurrence time of each of the neighboring base stations (Step a31 in FIG. 3). Examples of the predetermined frequency at which the handover occurrence times are referred include, without limitation, once a week or once a month. The handover management unit 124 determines whether handover has occurred during the time interval T from the past to the present for each of the neighboring base stations (a32). Examples of the time interval T, which is stored in the storage unit 125, include, without limitation, 24 hours. The base station to which no handover has occurred during the time interval T (a32: No) is determined as being the base station to be a candidate for deletion from the neighboring cell list (hereinafter, referred to as a “deletion candidate base station”) (a33). When there exists a base station to be the deletion candidate base station, the handover management unit 124 notifies the neighboring base station information management unit 122 of information on the deletion candidate base station (a34).

The neighboring base station information management unit 122 confirms whether the notified deletion candidate base station is the small base station (a35). The neighboring base station information management unit 122 can determine whether the notified deletion candidate base station is the small base station by referring to the cell type information acquired by the cell type information acquisition unit 126. When the cell type information is included in the neighboring cell list, the neighboring base station information management unit 122 refers to the neighboring cell list and confirms whether the deletion candidate base station is the small base station.

Note that the following description describes “delete the information on the base station from the neighboring cell list” and the like merely as “delete the base station from the neighboring cell list” and the like.

When the deletion candidate base station is not the small base station (a35: No), the neighboring base station information management unit 122 deletes the input deletion candidate base station from the neighboring cell list and updates the neighboring cell list (a36). However, when the deletion candidate base station is the small base station (a35: Yes), the neighboring base station information management unit 122 does not delete the deletion candidate base station from the neighboring cell list (a37). When handover has occurred at Step a32 (a32: Yes), the neighboring base station information management unit 122 does not delete the deletion candidate base station from the neighboring cell list, neither (a37). The updated neighboring cell list is informed to the terminal 4 (a38). The neighboring cell list is transmitted from the radio communication unit 13, as being the broadcast information generated by the neighboring base station information broadcasting unit 123.

As for the neighboring base station to which handover has never occurred since the installation, no handover occurrence time to be referred is present. Thus, when information on the neighboring base station to which handover has never occurred since the installation is referred immediately after the installation, it may be determined that no handover has occurred based on the presence or absence of handover in a time interval shorter than the time interval T, resulting in deletion of the base station. To prevent such a problem, the handover management table may store the installation time and the operation start time of each of the base stations. Then, the handover management unit 124 may confirm the presence or absence of handover occurrence by referring to these times as a first handover occurrence time.

According to the first exemplary embodiment, the neighboring cell list may be stored in the storage unit 125 for each base station. The neighboring cell list, however, may be stored outside the base station. For example, each of the base stations 1 to 3 may save the neighboring cell list in the SON server 200 instead of saving the neighboring cell list within each base station. In this case, when each of the base stations 1 to 3 refers to the neighboring cell list, the neighboring base station information management unit 122 accesses the neighboring cell list stored in the SON server 200 via the network communication unit 11.

Storing the neighboring cell list in each base station has the advantage of preventing tightness in the communication traffic between the SON server and the base station even when the neighboring cell list is frequently updated. Meanwhile, storing the neighboring cell list in the SON server enables the SON server to collectively update the neighboring cell lists for the plurality of base stations upon specification change in the system. In addition, in the case of replacement of the base station due to the failure, a new base station can immediately initiate operation using the neighboring cell list of the failed base station by using the neighboring cell list stored in the SON server 200. In the following exemplary embodiments, the neighboring cell list may be stored in each base station or may be stored in the SON server 200.

As described above, the base station 1 as being the source base station in the wireless communication system 100 according to the first exemplary embodiment updates the handover management table held by the own base station 1 based on the handover occurrence time and the information on the base station 2 as being the target base station. The base station 2 as being the target base station updates the handover management table held by the own base station 2 based on the handover occurrence time and the information on the base station 1 as being the source base station.

In addition, the base station stores the cell type information indicating whether each of the other base stations is the small base station or the non-small base station in correspondence with the information on each of the base stations.

As described above, the base station updates the handover management table and the neighboring cell list, and stores the cell type information in both the cases where the base station is the source base station or the base station is the target base station. Further, in the wireless communication system 100 according to the first exemplary embodiment, the base station to which no handover has occurred during the time interval T and which is the non-small base station is deleted from the neighboring cell list. Meanwhile, in the case of the base station to which no handover has occurred during a predetermined period of time but which is the small base station, the small base station is not deleted from the neighboring cell list.

In the wireless communication system 100 according to the first exemplary embodiment, managing the information on the neighboring base stations in the neighboring cell list which has a limitation on the number of registration while operating the wireless communication system enables the neighboring cell list to register the neighboring base stations with frequent handover occurrence in the operation state. Accordingly, the wireless communication system 100 according to the first exemplary embodiment achieves the effect of improving the handover performance of the overall wireless communication system.

In addition, in the wireless communication system 100 according to the first exemplary embodiment, the small base station, even being the candidate for deletion from the neighboring cell list, is not deleted from the neighboring cell list. Thus, the wireless communication system 100 according to the first exemplary embodiment enables to prevent the problem in which deleting the small base station from the neighboring cell list suppresses traffic offload from the macro cell to the small cells. Hence, the wireless communication system 100 according to the first exemplary embodiment also exhibits the effect of facilitating traffic offload to the small cells.

As described above, according to the first exemplary embodiment, the base station included in the neighboring cell list is deleted at the predetermined frequency from the neighboring cell list in accordance with a criterion different depending on whether the base station included in the neighboring cell list is the small base station having the subordinate small cell or the non-small base station. According to the first exemplary embodiment, only the base station included in the neighboring cell list in which no handover has been performed during the predetermined time interval and which is the non-small base station is deleted.

### Modification of First Exemplary Embodiment

The effect of the first exemplary embodiment is also achieved by a minimum configuration base station including the following configuration. Namely, the minimum configuration base station includes the neighboring cell list and the neighboring base station information management unit 122. The minimum configuration base station is a base station used for communication with a terminal existing in a cell subordinate to the base station. The neighboring cell list includes the information on the other base station around the base station. The neighboring base station information management unit 122 manages the neighboring cell list and deletes the base station included in the neighboring cell list at a predetermined frequency from the neighboring cell list in accordance with a predetermined criterion. At this time, the predetermined criterion differs depending on whether the base station included in the neighboring cell list is a small base station having a subordinate small cell or a non-small base station.

The base station including such a minimum configuration uses the different criteria in deleting the base station from the neighboring cell list. This makes it possible to set different ratios for deleting the small base station and the non-small base station from the neighboring cell list. As a result, the base station including the minimum configuration enables to prevent the problem in which deleting the small base station from the neighboring cell list suppresses traffic offload from the macro cell to the small cell. Consequently, the minimum configuration base station exhibits the effect of facilitating traffic offload to the small cells.

### Second Exemplary Embodiment

In the wireless communication system 100 according to the first exemplary embodiment, the non-small base station with less frequent handover is deleted from the neighboring cell list. However, deleting the non-small base station increases the proportion of the small base stations included in the neighboring cell list and, as a result, more traffic may be loaded onto the small base stations, leading to the tight transmission capacity of the small base stations. A second exemplary embodiment describes the procedure of updating the neighboring cell list for the purpose of preventing the increase in the proportion of the small base stations included in the neighboring cell list.

According to the second exemplary embodiment, whether to delete the base station from the neighboring cell list is determined based on the cell type information of the base station and a number of times of handover occurrence during a predetermined time interval of the base station. According to the second exemplary embodiment, the number of times of handover as a reference for deletion from the neighboring cell list differs depending on whether the base station included in the neighboring cell list is a small base station having a subordinate small cell or a non-small base station.

The configurations and the basic operations of the base stations according to the second exemplary embodiment are the same as in FIG. 1 and FIG. 2. In the second exemplary embodiment, however, the procedure of updating the neighboring cell list at Steps a22 and a23 in FIG. 2 is different from the first exemplary embodiment. In addition, given a predetermined time interval T, the handover management unit 124 according to the second exemplary embodiment records a history of handover in the handover management table for each of the neighboring base stations so as to determine the number of times of handover occurrence during the time interval T.

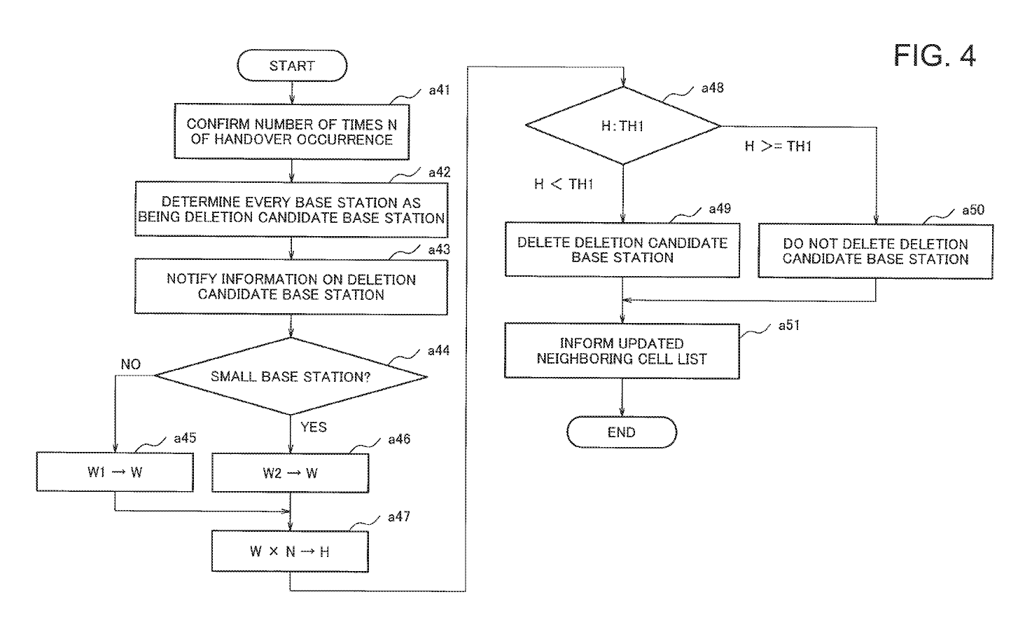

The following describes a procedure of updating the neighboring cell list according to the second exemplary embodiment. FIG. 4 is a flowchart illustrating the procedure of updating the neighboring cell list according to the second exemplary embodiment. The procedure in FIG. 4 corresponds to Steps a22 and a23 in the first exemplary embodiment and is common between the source base station (base station 1) and the target base station (base station 2).

The handover management unit 124 of the base station 1 or the base station 2 refers to the handover management table held by the own handover management unit 124 at a predetermined frequency and determines a number of times N of handover occurrence during a predetermined time interval T for all the neighboring base stations (a41). Examples of the predetermined frequency at which the handover occurrence times are referred include, without limitation, once a week or once a month. In addition, examples of the time interval T include, without limitation, 24 hours. The handover management unit 124 determines the number of times N of handover occurrence between the present and the time point in the past by the time interval T back from the present. The second exemplary embodiment determines every neighboring base station as being a deletion candidate base station, regardless of the presence or absence of handover occurrence (a42). The handover management unit 124 notifies the neighboring base station information management unit 122 of information on the deletion candidate base station (a43).

The neighboring base station information management unit 122 confirms whether the notified deletion candidate base station is the small base station (a44). The neighboring base station information management unit 122 can determine whether the notified deletion candidate base station is the small base station by referring to the cell type information.

The neighboring base station information management unit 122 sets coefficients W1 and W2. The coefficient W1 is a coefficient for the case where the deletion candidate base station is the non-small base station (a44: No to a45). The coefficient W2 is a coefficient for the case where the deletion candidate base station is the small base station (a44: Yes to a46). The coefficients W1 and W2 satisfy the relation 0<W1<W2. The coefficients W1 and W2 may be preliminarily stored in the storage unit 125. The neighboring base station information management unit 122 computes a handover index H using the following expressions (1) and (2) (a47). The handover index H corresponds to H1 when the deletion candidate base station is the non-small base station and corresponds to H2 when the deletion candidate base station is the small base station.

H1=W1×N (1)

H2=W2×N (2)

Where W1<W2, and thus H1<H2.

The neighboring base station information management unit 122 compares the computed handover index H (H1 and H2) with a handover threshold value TH1 (a48). When the handover index H of the deletion candidate base station is less than the handover threshold value TH1 (a48: H<TH1), the neighboring base station information management unit 122 deletes the deletion candidate base station from the neighboring cell list regardless of whether the deletion candidate base station is the small base station (a49). Meanwhile, when the handover index H is equal to or greater than TH1 (a48: H≧TH1), the neighboring base station information management unit 122 does not delete the deletion candidate base station from the neighboring cell list regardless of whether the cell of the deletion candidate base station is the small cell (a50). The updated neighboring cell list is notified to the terminal 4 (a51).

In this connection, for the case where the handover index H and the handover threshold value TH1 satisfy the relation H1<TH1<H2, the deletion candidate base station is deleted from the neighboring cell list only when the deletion candidate base station is the non-small base station. As described above, according to the second exemplary embodiment, the number of times N of handover is weighted based on the cell type information of the deletion candidate base station. Further, as a result, the number of times of handover for deletion from the neighboring cell list is weighted more in the small base station than in the non-small base station.

Namely, in the procedure of updating the neighboring cell list according to the second exemplary embodiment, the small base station is also determined as being the target for deletion, but the small base station is deleted from the neighboring cell list when the number of times of handover is W2/W1 times or more the case of the non-small base station.

According to the second exemplary embodiment, the neighboring base station information management unit 122 determines whether to delete the deletion candidate base station from the neighboring cell list in accordance with the result of weighting the number of times N of handover based on the cell type information of the deletion candidate base station. In this way, in the procedure of updating the neighboring cell list according to the second exemplary embodiment, the small base station is also determined as being the target for deletion, but the small base station is less likely to be deleted from the neighboring cell list than the non-small base station.

Thus, the second exemplary embodiment facilitates traffic offload to the small base stations and prevents the increase in the proportion of the small base stations included in the neighboring cell list in comparison with the case where the small base station is not determined as being the target for deletion.

The values of the coefficients W1 and W2 and the handover threshold value TH1, and the magnitude relation therebetween are not limited to the values and the relation as described above. The values of the coefficients W1, W2 and the handover threshold value TH1 can be changed by the neighboring base station information management unit 122 to manage the degree of enhancing the deletion of the non-small base station in comparison with the small base station.

### Third Exemplary Embodiment

In the second exemplary embodiment, the handover index H (H1 and H2) is calculated based on the number of times of handover included in the handover management table. However, the neighboring base station information management unit 122 may calculate the handover index H based on the communication quality of the deletion candidate base station.

According to the third exemplary embodiment, the base station included in the neighboring cell list is deleted from the neighboring cell list in accordance with a criterion different depending on whether the base station included in the neighboring cell list is a small base station having a subordinate small cell or a non-small base station. According to the third exemplary embodiment, the criterion for deleting the base station is set based on the cell type information and the communication quality of the base station.

The configurations and the basic operations of the base stations according to the third exemplary embodiment are the same as in FIG. 1, FIG. 2 and FIG. 4. In the third exemplary embodiment, however, the procedure of updating the neighboring cell list at Steps a22 and a23 in FIG. 2 is different from the first and second exemplary embodiments. The following describes only the difference from the second exemplary embodiment.

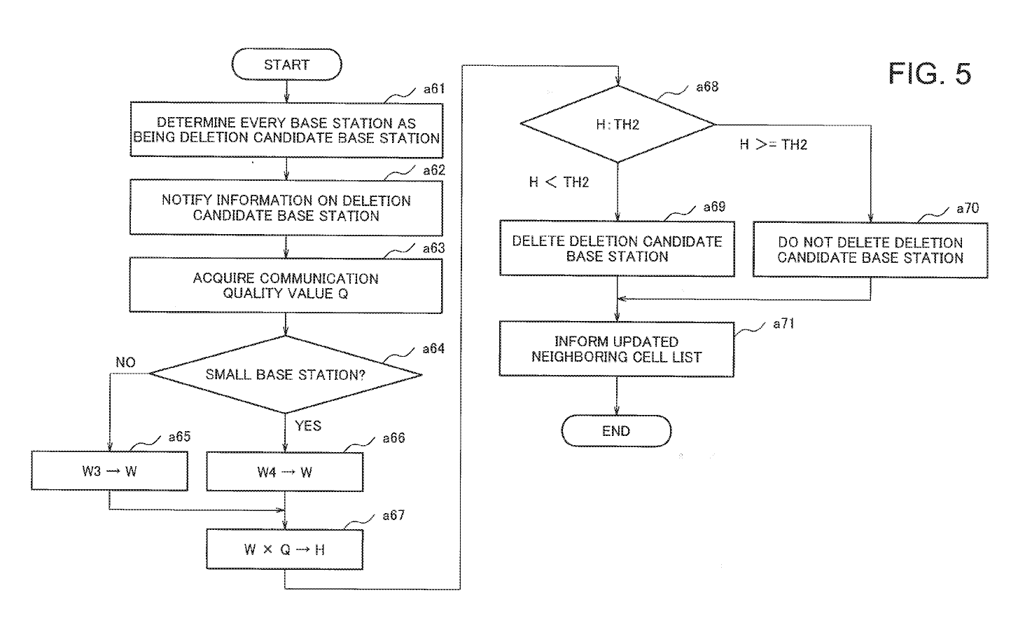

The following describes a procedure of updating the neighboring cell list according to the third exemplary embodiment. FIG. 5 is a flowchart illustrating the procedure of updating the neighboring cell list according to the third exemplary embodiment. The procedure in FIG. 5 is common between the source base station (base station 1) and the target base station (base station 2).

The third exemplary embodiment, as is the case in the second exemplary embodiment, determines every neighboring base station as being a deletion candidate base station, regardless of the presence or absence of handover occurrence (a61). The handover management unit 124 notifies the neighboring base station information management unit 122 of information on the deletion candidate base station (a62).

The neighboring base station information management unit 122 refers to the neighboring cell list and acquires a communication quality value Q for all the deletion candidate base stations (a63). The communication quality value Q is a numerical value indicating whether the communication quality between the base station and the terminal is good or bad by stages, and is obtained based on, for example, communication quality information included in the Measurement Report from the terminal 4. According to the third exemplary embodiment, it is assumed that the communication quality value Q is a numerical value of 0 or more but 1 or less, with Q=0 for the lowest communication quality and Q=1 for the highest communication quality.

The neighboring base station information management unit 122 confirms whether the notified deletion candidate base station is a small base station (a64). The neighboring base station information management unit 122 sets coefficients W3 and W4 (a65, a66). The coefficient W3 is a coefficient for the case where the deletion candidate base station is the non-small base station. The coefficient W4 is a coefficient for the case where the deletion candidate base station is the small base station. The coefficients W3 and W4 satisfy the relation 0<W3<W4. The coefficients W3 and W4 may be preliminarily stored in the storage unit 125. The neighboring base station information management unit 122 computes a handover index H using the following expressions (3) and (4) (a67). The handover index H corresponds to H3 when the deletion candidate base station is the non-small base station and corresponds to H4 when the deletion candidate base station is the small base station.

H3=W3×Q (3)

H4=W4×Q (4)

Where W3<W4, and thus H3<H4.

The neighboring base station information management unit 122 compares the computed handover index H (H3 and H4) with a handover threshold value TH2 (a68). When the handover index H of the deletion candidate base station is less than the handover threshold value TH2 (a68: H<TH2), the neighboring base station information management unit 122 deletes the deletion candidate base station from the neighboring cell list regardless of whether the deletion candidate base station is the small base station (a69). Meanwhile, when the handover index H is equal to or greater than TH2 (a68: H≧TH2), the neighboring base station information management unit 122 does not delete the deletion candidate base station from the neighboring cell list regardless of whether the cell of the deletion candidate base station is the small cell (a70). The updated neighboring cell list is informed to the terminal 4 (a71).

In this connection, for the case where the handover index H and the handover threshold value TH2 satisfy the relation H3<TH2<H4, the deletion candidate base station is deleted from the neighboring cell list only when the deletion candidate base station is the non-small base station. As described above, according to the third exemplary embodiment, the communication quality information Q is weighted based on the cell type information of the deletion candidate base station. Further, when the communication quality Q takes the same value, the handover index H4 for the small base station becomes larger than the handover index H3 for the non-small base station. Consequently, the small base station is less likely to be deleted from the neighboring cell list than the non-small base station.

In this way, in the procedure of updating the neighboring cell list according to the third exemplary embodiment, the small base station is also determined as being the target for deletion, but the small base station is deleted from the neighboring cell list when the communication quality Q is W4/W3 times or more the case of the non-small base station.

Thus, the third exemplary embodiment, as is the case in the second exemplary embodiment, facilitates traffic offload to the small base stations and prevents the increase in the proportion of the small base stations included in the neighboring cell list in comparison with the case where the small base station is not determined as being the target for deletion.

The values of the coefficients W3 and W4 and the handover threshold value TH2, and the magnitude relation therebetween are not limited to the values and the relation as described above. The values of the coefficients W3 and W4 and the handover threshold value TH2 can be changed by the neighboring base station information management unit 122 to manage the degree of prioritizing the deletion of the non-small base station in comparison with the small base station.

### Fourth Exemplary Embodiment

Furthermore, the number of times N of handover described in the second exemplary embodiment and the communication quality value Q described in the third exemplary embodiment may be combined to obtain the handover indices H5 and H6 using the following expressions (5) and (6).

H5=p×H1+(1−p)×H3 (5)

H6=p×H2+(1−p)×H4 (6)

Where p is a constant that satisfies 0≦p≦1. The case when p=1 corresponds to the second exemplary embodiment, and the case when p=0 corresponds to the third exemplary embodiment. Using the handover indices H5 and H6 obtained by the expressions (5) and (6) enables to determine whether to delete the deletion candidate base station from the neighboring cell list in the same manner as the second and third exemplary embodiments. Setting the constant p enables to manage the weighting of the number of times N of handover and the communication quality value Q in the handover indices H5 and H6.

As described above, in the procedures of updating the neighboring cell list according to the second to fourth exemplary embodiments, the criterion for deleting the base station from the neighboring cell list is set based on at least one of the number of times of handover and the communication quality value of the deletion candidate base station.

The procedures of updating the neighboring cell list according to the second to fourth exemplary embodiments, as is the case in the first exemplary embodiment, exhibit the effect of facilitating traffic offload to the small cells. Further, the procedures of updating the neighboring cell list according to the second to fourth exemplary embodiments set the different criteria for deleting the small base station and the non-small base station from the neighboring cell list, thereby enabling to prevent excess traffic to be offloaded to the small base stations due to a large number of the non-small base stations deleted.

While the present invention has been described with reference to exemplary embodiments, the present invention is not limited to the exemplary embodiments described above. Various modifications understood by a person skilled in the art can be made to configuration and details of the present invention within the scope of the present invention.

This application is based upon and claims the benefit of priority from Japanese Patent Application No. 2014-055285, filed on Mar. 18, 2014, the disclosure of which is incorporated herein in its entirety by reference.

Note that the exemplary embodiments of the present invention can be described as the following supplementary notes but the present invention is not limited to the following.

(Supplementary Note 1)

A base station used for communication with a terminal existing in a cell subordinate to the base station, including:

a neighboring cell list including information on other base stations around the base station; and

neighboring base station information management means for managing the neighboring cell list and deleting information on a base station included in the neighboring cell list at a predetermined frequency from the neighboring cell list in accordance with a criterion different depending on whether the base station included in the neighboring cell list is a small base station having a subordinate small cell or a non-small base station.

(Supplementary Note 2)

The base station according to the supplementary note 1, wherein the small cell is a cell covering a narrower service area than a macrocell.

(Supplementary Note 3)

The base station according to the supplementary note 1 or 2, further including:

first communication means for communicating with the terminal;

second communication means for communicating with the other base stations;

cell type information acquisition means for acquiring cell type information indicating whether a cell subordinate to corresponding one of the other base stations is the small cell or the non-small cell;

handover processing means for determining a handover destination base station for the terminal;

a handover management table which stores handover occurrence times each of which indicates a time of occurrence of handover to the handover destination base station and information on the handover destination base station; and

handover management means for managing the handover management table.

(Supplementary Note 4)

The base station according to the supplementary note 3, wherein the handover management means

extracts a base station to which no handover has occurred during a predetermined time interval as a deletion candidate base station among the base stations included in the neighboring cell list at the predetermined frequency from the handover management table;

does not delete information on the deletion candidate base station from the neighboring cell list when the deletion candidate base station is the small base station; and

deletes the information on the deletion candidate base station from the neighboring cell list when the deletion candidate base station is the non-small base station.

(Supplementary Note 5)

The base station according to the supplementary note 3, wherein the criterion is set based on a number of times of handover occurrence during a predetermined time interval.

(Supplementary Note 6)

The base station according to the supplementary note 5, wherein the handover management means

multiplies the number of times of handover occurrence by a coefficient different depending on whether the base station included in the neighboring cell list is the small base station or the base station included in the neighboring cell list is the non-small base station; and

determines whether to delete the information on the base station included in the neighboring cell list from the neighboring cell list at the predetermined frequency based on a result of comparison between a result of the multiplication and a predetermined threshold value.

(Supplementary Note 7)

The base station according to the supplementary note 3, wherein the criterion is set based on a numerical value indicating communication quality with each of the other base stations notified from the terminal.

(Supplementary Note 8)

The base station according to the supplementary note 7, wherein the handover management means

multiplies the numerical value indicating the communication quality by a coefficient different depending on whether the base station included in the neighboring cell list is the small base station or the base station included in the neighboring cell list is the non-small base station; and

determines whether to delete the information on the base station included in the neighboring cell list from the neighboring cell list at the predetermined frequency based on a result of comparison between a result of the multiplication and a predetermined threshold value.

(Supplementary Note 9)

The base station according to any one of the supplementary notes 1 to 8, wherein the neighboring cell list is stored within the base station.

(Supplementary Note 10)

A communication system including the base station according to any one of the supplementary notes 3 to 9 and a terminal, wherein the terminal is configured to communicate with the first communication means of the base station.

(Supplementary Note 11)

The communication system according to the supplementary note 10, further including a Self Organized Network (SON) server capable of communicating with the base station, wherein

the SON server stores the neighboring cell list.

(Supplementary Note 12)

A method for controlling a base station, the method including deleting, at a predetermined frequency from a neighboring cell list, information on a base station included in the neighboring cell list including information on base stations used in a mobile communication system, in accordance with a criterion different depending on whether the base station included in the neighboring cell list is a small base station having a subordinate small cell or a non-small base station.

(Supplementary Note 13)

A program for controlling a base station, the program causing a computer of a base station used for communication with a terminal existing in a cell subordinate to the base station to operate as:

means for managing a neighboring cell list including information on other base stations around the base station; and

means for deleting information on the base station included in the neighboring cell list at a predetermined frequency from the neighboring cell list in accordance with a criterion different depending on whether the base station included in the neighboring cell list is a small base station having a subordinate small cell or a non-small base station.

### REFERENCE SIGNS LIST

1, 2, 3 Base station
4 Terminal
11 Network communication unit
12 Base station operation unit
13 Radio communication unit
121 Handover processing unit
122 Neighboring base station information management unit
123 Neighboring base station information broadcasting unit
124 Handover management unit
125 Storage unit
126 Cell type information acquisition unit
127 CPU
128 Memory
200 SON server

1. A base station used for communication with a terminal existing in a cell subordinate to the base station, comprising:
a neighboring cell list including information on other base stations around the base station; and
a neighboring base station information management unit that manages the neighboring cell list and deleting information on a base station included in the neighboring cell list at a predetermined frequency from the neighboring cell list based on a criterion different depending on whether the base station included in the neighboring cell list is a small base station having a subordinate small cell or a non-small base station.

2. The base station according to claim 1, wherein the small cell is a cell covering a narrower service area than a macrocell.

3. The base station according to claim 1, further comprising:
a first communication unit that communicates with the terminal;
a second communication unit that communicates with the other base stations;
a cell type information acquisition unit that acquires cell type information indicating whether a cell subordinate to one of the other base stations is the small cell or the non-small cell;
a handover processing unit that determines a handover destination base station for the terminal;
a handover management table which stores a handover occurrence time being a time of occurrence of handover to the handover destination base station and information on the handover destination base station; and
a handover management unit that manages the handover management table.

4. The base station according to claim 3, wherein the handover management unit
extracts a base station to which no handover has occurred during a predetermined time interval as a deletion candidate base station among base stations included in the neighboring cell list at the predetermined frequency from the handover management table;
does not delete information on the deletion candidate base station from the neighboring cell list when the deletion candidate base station is the small base station; and
deletes information on the deletion candidate base station from the neighboring cell list when the deletion candidate base station is the non-small base station.

5. The base station according to claim 3, wherein the criterion is set based on a number of times of handover occurrence during a predetermined time interval.

6. The base station according to claim 5, wherein the handover management unit
multiplies the number of times of handover occurrence by a coefficient different depending on whether the base station included in the neighboring cell list is the small base station or the base station included in the neighboring cell list is the non-small base station; and
determines whether to delete information on the base station included in the neighboring cell list from the neighboring cell list at the predetermined frequency based on a result of comparison between a result of the multiplication and a predetermined threshold value.

7. The base station according to claim 3, wherein
the criterion is set based on a numerical value indicating communication quality with the other base station notified from the terminal, and
the handover management unit
multiplies the numerical value indicating the communication quality by a coefficient different depending on whether the base station included in the neighboring cell list is the small base station or the base station included in the neighboring cell list is the non-small base station; and
determines whether to delete information on the base station included in the neighboring cell list from the neighboring cell list based on a result of comparison between a result of the multiplication and a predetermined threshold value.

8. A communication system comprising the base station according to claim 3 and a terminal, wherein the terminal is configured to communicate with the first communication unit of the base station.

9. The communication system according to claim 8, further comprising
a Self Organized Network (SON) server capable of communicating with the base station, wherein
the SON server stores the neighboring cell list.

10. A method for controlling a base station, the method comprising deleting, at a predetermined frequency from a neighboring cell list, information on a base station included in the neighboring cell list including information on base stations used in a mobile communication system, based on a criterion different depending on whether the base station included in the neighboring cell list is a small base station having a subordinate small cell or a non-small base station.

11. The base station according to claim 2, further comprising:
a first communication unit that communicates with the terminal;
a second communication unit that communicates with the other base stations;
a cell type information acquisition unit that acquires cell type information indicating whether a cell subordinate to one of the other base stations is the small cell or the non-small cell;
a handover processing unit that determines a handover destination base station for the terminal;
a handover management table which stores a handover occurrence time being a time of occurrence of handover to the handover destination base station and information on the handover destination base station; and
a handover management unit that manages the handover management table.

12. The base station according to claim 11, wherein the handover management unit
extracts a base station to which no handover has occurred during a predetermined time interval as a deletion candidate base station among base stations included in the neighboring cell list at the predetermined frequency from the handover management table;
does not delete information on the deletion candidate base station from the neighboring cell list when the deletion candidate base station is the small base station; and
deletes information on the deletion candidate base station from the neighboring cell list when the deletion candidate base station is the non-small base station.

13. The base station according to claim 11, wherein the criterion is set based on a number of times of handover occurrence during a predetermined time interval.

14. The method according to claim 10, wherein the small cell is a cell covering a narrower service area than a macrocell.

15. The method according to claim 10, further comprising:
communicating with the terminal;
communicating with the other base stations;
acquiring cell type information indicating whether a cell subordinate to one of the other base stations is the small cell or the non-small cell;
determining a handover destination base station for the terminal;
storing a handover occurrence time being a time of occurrence of handover to the handover destination base station and information on the handover destination base station in a handover management table; and
managing the handover management table.

16. The method according to claim 14, further comprising:
communicating with the terminal;
communicating with the other base stations;
acquiring cell type information indicating whether a cell subordinate to one of the other base stations is the small cell or the non-small cell;
determining a handover destination base station for the terminal;
storing a handover occurrence time being a time of occurrence of handover to the handover destination base station and information on the handover destination base station in a handover management table; and
managing the handover management table.

17. The method according to claim 15, further comprising:
extracting a base station to which no handover has occurred during a predetermined time interval as a deletion candidate base station among base stations included in the neighboring cell list at the predetermined frequency from the handover management table;
not deleting information on the deletion candidate base station from the neighboring cell list when the deletion candidate base station is the small base station; and
deleting information on the deletion candidate base station from the neighboring cell list when the deletion candidate base station is the non-small base station.

18. The method according to claim 16, further comprising:
extracting a base station to which no handover has occurred during a predetermined time interval as a deletion candidate base station among base stations included in the neighboring cell list at the predetermined frequency from the handover management table;
not deleting information on the deletion candidate base station from the neighboring cell list when the deletion candidate base station is the small base station; and
deleting information on the deletion candidate base station from the neighboring cell list when the deletion candidate base station is the non-small base station.
